(19) United States
(12) Patent Application Publication
(10) Pub. No.: US 2020/0050912 A1
(43) Pub. Date: Feb. 13, 2020

(54) ELECTRONIC IDENTIFIER FOR PACKAGING

(71) Applicant: PARKSIDE FLEXIBLES (EUROPE) LIMITED, West Yorkshire (GB)

(72) Inventors: STEVE MCCORMICK, West Yorkshire (GB); MARK SHAW, West Yorkshire (GB)

(21) Appl. No.: 16/342,470

(22) PCT Filed: Oct. 16, 2017
(86) PCT No.: PCT/GB2017/053124

§ 371 Date: Apr. 16, 2019

(30) Foreign Application Priority Data
Oct. 17, 2016 (GB) 1617580.4

(51) Int. Cl. G06K 19/07; G06K 19/077; H01Q 1/22

(52) U.S. Cl. CPC G06K 19/0723; H01Q 1/2208; G06K 19/07773

(57) ABSTRACT

A packaging film (1) including a sheet (10) of plastics material with an antenna (2) formed of a non-metallic material printed directly on a major surface (11) of the sheet (10) and an electronic identification device (3) operatively connected to the antenna (2). The electronic identification device (3) is secured to the film (1) by a conductive adhesive (4) and is less than 1 mm2 in plan so that the film is effectively invisible to or undetectable by a metal detector.

This invention relates generally to identification devices and more particularly to electronic identifiers for packaging. More specifically, although not exclusively, this invention relates to a packaging film with an electronic identifier incorporated therein or thereon.

It is known to affix electronic identification devices to objects as a means to track and manage inventory, assets and people. One such electronic identification device is a radio-frequency identification (RFID) tag. RFID technology makes use of electromagnetic fields to identify and track automatically tags attached to objects and containing information stored electronically therein.

Unlike conventional identification tags, such as barcodes, RFID tags need not be within the line of sight of the reader. This enables the tag to be embedded in the tracked object. Passive RFID tags collect energy from an adjacent reader via interrogating radio waves. Active tags transmit radio waves and may operate at hundreds of meters from the reader, but require a local power source such as a battery.

RFID tags are generally used for high value items, such as automobiles for tracking progress through assembly or pharmaceuticals for tracking their location through warehouses. RFID is also being adopted for some item level tagging in retail environments to provide electronic article surveillance, self-checkout, and/or inventory management.

However, the use of such tags in a retail environment tends to be limited to high value products. The cost and complexity of applying RFID tags to fast moving consumer goods (FMCG) has to date precluded their widespread use in retail environments.

The applicants have observed that conventional RFID tags can be unsightly or at least have a negative impact on the aesthetics of a product or its packaging. The applicants have also observed that RFID tags are prone to removal from products, either accidentally during transportation or handling or deliberately, for example by shoplifters seeking to evade anti-theft RFID tracking systems.

It is therefore a first non-exclusive object of the invention to provide an electronic identification means which is cost effective and/or less prone to removal from a product or its packaging. It is a further non-exclusive object of the invention to provide an electronic identification means that at least mitigates one or more issues with prior art devices. It is a yet further non-exclusive object of the invention to provide an improved identification device and system for tracking such a device.

Accordingly, a first aspect of the invention provides a packaging medium, e.g. a film, which may be flexible, or a rigid medium, the medium comprising an antenna for an electronic identification device printed on a surface thereof, e.g. printed directly or indirectly on a surface thereof.

By printing the antenna on a surface of the packaging medium, rather than the subsequent placing of a complete tag on the package, production costs can be reduced. In addition, strategic placing of the surface on which the antenna is printed can inhibit access and thereby improve security.

One issue with conventional electronic identification devices, which has been observed by the applicants, is that the metal content in the antenna may be visible to metal detectors. This precludes the incorporation of such electronic identification devices directly into food packaging. Thus, the devices must be applied after the pack has been produced, either by hand or through a label applicator. This increases the cost of manufacture and generally results in the device being accessible making it easier to remove.

The antenna preferably comprises or, more preferably, is formed of a non-metallic material. The non-metallic material comprises a carbon or silica material. The antenna or antenna material may have a sheet resistivity of between 0.5 and 100 Ohms or Ohms/sq, for example between 1 and 80 Ohms or Ohms/sq, but preferably between 5 and 40 Ohms or Ohms/sq, for example between 10 and 20 Ohms or Ohms/sq. The non-metallic material may comprise a graphene, graphene oxide or fullerene material. The antenna may comprise or be printed from a carbon or silica ink, which may comprise a polymer and/or may be curable. The antenna or antenna material may comprise a conductive heat cured black carbon ink. The antenna or antenna material, for example the conductive heat cured black carbon ink, may have a sheet resistivity, e.g. at 25 μm, of approximately 10 to 20 Ohms or Ohms/sq. The antenna may be invisible to or undetectable by a metal detector.

The medium or film may comprise an electronic identification device, which may be mounted to or on the medium or film and/or operatively connected to the antenna. The electronic identification device may comprise an integrated circuit. The electronic identification device may comprise a radio frequency identification device or tag or a radio frequency identifier. The electronic identification device may be active, e.g. with a power source connected thereto or comprised therein. The electronic identification device may be passive and may be operable or configured to respond to and/or collect energy from a reader, e.g. via interrogating radio waves. The electronic identification device may comprise or be formed of non-metallic materials, e.g. exclusively non-metallic materials.

In order to ensure that the medium or film remains effectively invisible to or undetectable by a metal detector, it is preferable to minimise the size of the electronic identification device or integrated circuit and any metallic components incorporated therein.

The electronic identification device or integrated circuit may comprise a packaged silicon chip, which may have a maximum dimension of between 1 mm and 2 mm.

The electronic identification device or integrated circuit may be less than 1 mm² in plan and/or have a maximum dimension of 1 mm or 2 mm. In embodiments, the electronic identification device or integrated circuit is less than 0.5 mm² in plan and/or has a maximum dimension of 0.8 mm or 0.7 mm. Most preferably, the electronic identification device or integrated circuit is less than 0.4 mm² or 0.3 mm² in plan and/or has a maximum dimension of 0.4 mm or 0.5 mm. The electronic identification device or integrated circuit may comprise a bare die silicon chip.

In embodiments, the electronic identification device or integrated circuit is devoid or free of metal parts that are larger or longer than 0.5 mm or 0.4 mm. Preferably, the electronic identification device or integrated circuit is devoid or free of metal parts that are larger or longer than 0.3 mm or 0.2 mm. More preferably, the electronic identification device or integrated circuit is devoid or free of metal parts that are larger or longer than 0.1 mm, most preferably 0.05 mm. In some embodiments, the electronic identification device or integrated circuit may be substantially free of metal.

The electronic identification device may be sandwiched between the antenna and a protective layer, e.g. a non-metallic protective layer. In embodiments, the protective layer comprises a coating. In embodiments, the medium or film comprises a laminate and the protective layer comprises one of the layers of the laminate. In embodiments, the medium or medium or film comprises both a coating and a laminate. The coating may comprises an epoxy material.

The medium or film may advantageously comprise a conductive mesh or mesh pattern, which may be printed on the surface and/or may be in contact with the antenna. The conductive mesh or mesh pattern may comprise a sheet resistivity of less than 1 Ohm or Ohm/sq, preferably less than 0.5 Ohms or Ohms/sq, for example less than 0.1 Ohms or Ohms/sq. The conductive mesh or mesh pattern may comprise a conductive material, such as a metallic material, e.g. a silver material such as silver or silver alloy.

The applicants have found the inclusion of a conductive mesh or mesh pattern to be particularly effective at enhancing the effectiveness of a non-metallic antenna. The applicants have also observed that the conductive mesh or mesh pattern can be formed of a metallic material whilst still remaining effectively invisible to or undetectable by a metal detector.

The conductive mesh or mesh pattern may comprise a thickness of 50 μm or less, for example 40 μm or less, e.g. 30 μm or less. Preferably, the thickness of the conductive mesh or mesh pattern is 20 μm or less, more preferably 15 μm or less and most preferably 10 μm or less. Whilst the precise thickness will depend upon performance requirements, the applicants have determined that the thickness of the conductive mesh or mesh pattern can be less than 5 μm.

The conductive mesh may comprise a surface area coverage or fill factor of 30% or less. Preferably, the conductive mesh comprises a surface area coverage or fill factor of 20% or less, for example between 1% and 20% and more preferably 15% or less, such as between 5% and 15%. A particularly suitable coverage or fill factor is between 8% and 12%, such as approximately 10%.

The thickness of the antenna is preferably 200 μm or less, for example 150 μm or less. The thickness of the antenna is more preferably 100 μm or less, for example 75 μm or less and most preferably between 10-50 μm, e.g. 30 μm.

The medium or film may comprises a laminate with a first layer on which the antenna is printed, and a second layer secured to the first layer, for example such that the antenna and, if present, the electronic identification device and/or the conductive mesh or mesh pattern is or are sandwiched between the layers. In embodiments, the antenna may be sandwiched between the layers, whilst the electronic identification device may be configured to penetrate one of the layers to connect to the antenna.

The medium or film or at least one layer thereof may comprise a thickness of 500 μm or less, such as 400 μm or less. Preferably, however, the medium or film or at least one layer thereof comprises a thickness of 300 μm or less, more preferably 200 μm or less, such as 150 μm or less, e.g. 100 μm or less or even 50 μm or less. The medium or film is preferably at least 5 μm, more preferably at least 7 μm, 8 μm or 9 μm, for example at least 10 μm.

The medium or film may comprise a plastics medium or film that may comprise one or more layers of plastics sheet material. The, or each layer of the plastics sheet material(s) may comprise any suitable thickness. The, or one of the plastics sheet material(s) may comprise a polyester material, for example a polyethylene terephthalate or polylactic acid material, a polypropylene material, a polyethylene material, a polyvinyl chloride material or an aliphatic or semi-aromatic polyamide material (e.g. a Nylon material). In one embodiment, the medium or film comprises a single sheet of polyethylene terephthalate material having a thickness of approximately 100 μm. In other embodiments, the medium or film may comprise two or more such sheets, e.g. laminated together, either one or both of which need not comprise polyethylene terephthalate material.

The electronic identification device or integrated circuit may be secured to the medium or film, for example by an adhesive which may be conductive, e.g. a conductive adhesive. The adhesive may comprise a metallic material, for example silver, or some other conductive material. In embodiments, the adhesive comprises a silver based conductive epoxy material. The adhesive may comprise a carbon based conductive epoxy material.

Another aspect of the invention provides a roll of packaging medium or film, for example a packaging medium or film as described above. The roll may comprise one or more electronic identification device antennae printed directly on a surface of the medium or film. The roll may further comprise one or more electronic identification devices mounted to the medium or film and/or operatively connected to the or a respective antenna.

Another aspect of the invention provides a package, which may comprise a packaging medium or film as described above. The package may comprise an electronic identification device antenna printed on, e.g. directly on, a surface thereof, e.g. on a surface of the medium of film. The antenna may be printed on an internally facing surface of the package, e.g. directly thereon. The package may comprise an electronic identification device mounted thereto and/or operatively connected to the antenna.

Another aspect of the invention provides an apparatus for forming a package or a packaging medium or film, for example a package or a packaging medium or film as described above. The apparatus may include one or more of an antenna printing station, a conductive mesh pattern printing station, an identification device depositing station, a coating station and/or a laminating station. The apparatus may include a first roll of sheet material and/or a second roll of sheet material.

Another aspect of the invention provides an inventory monitoring system, which may comprise an electronic identification device reader and/or one or more, e.g. a plurality of, packages as described above. The monitoring system may comprise one or more, e.g. a plurality of, packages as described above, one or more, e.g. a plurality of, electronic identification device readers, one or more, e.g. a plurality of, image capture devices, such as video cameras, and/or a control station.

Yet another aspect of the invention provides a method of making a package or a packaging medium or film, e.g. a package or a packaging medium or film as described above. The method may comprise providing a package or a length of film and printing an electronic identification device antenna directly on a surface thereof. The method may comprise providing a first layer and printing an electronic identification device antenna directly on a surface thereof.

The method may comprise printing, securing or otherwise providing or placing a conductive mesh or mesh pattern, for example on the surface and/or in contact with the antenna.

The method may comprise placing and/or securing an electronic identification device on the surface, e.g. such that it is in contact with or operatively connected, e.g. electrically connected, to the antenna. The method may comprise securing the electronic identification device to the surface using an adhesive, which may comprise a conductive adhesive, e.g. to provide or enhance the operative or electrical connection with the antenna. The method may comprise covering the electronic identification device with a layer, e.g. a protective and/or non-metallic layer.

The method may comprise laminating a second layer on or to the first layer, for example such that it covers the antenna and, if present, the conductive mesh or mesh pattern and, if present, the electronic identification device. The method may comprise coating the electronic identification device, which may be done before the second layer is laminated on or to the first layer, e.g. such that the second layer covers the coated electronic device.

In embodiments, the method comprises coating the electronic identification device without laminating a second layer on or to a first layer.

The method may comprise providing a length of packaging medium or film and printing a plurality of antennas on a surface thereof. The method may comprise rolling or compiling or gathering onto a roll the printed medium or film, for example before or after the placement or securing of the electronic identification device thereon or thereto. The method may comprise rolling or compiling or gathering onto a roll the laminated medium or film.

For the avoidance of doubt, any of the features described herein apply equally to any aspect of the invention. For example, the package may comprise any one or more features of the medium or film or vice versa. Similarly, the method may comprise any one or more features or steps relevant to one or more features of the medium or film or the package.

Another aspect of the invention provides a computer program element comprising and/or describing and/or defining a three-dimensional design for use with a simulation means or a three-dimensional additive or subtractive manufacturing means or device, e.g. a three-dimensional printer or CNC machine, the three-dimensional design comprising an embodiment of the packaging medium or film or package described above. A yet further aspect of the invention provides the computer program element embodied on a computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

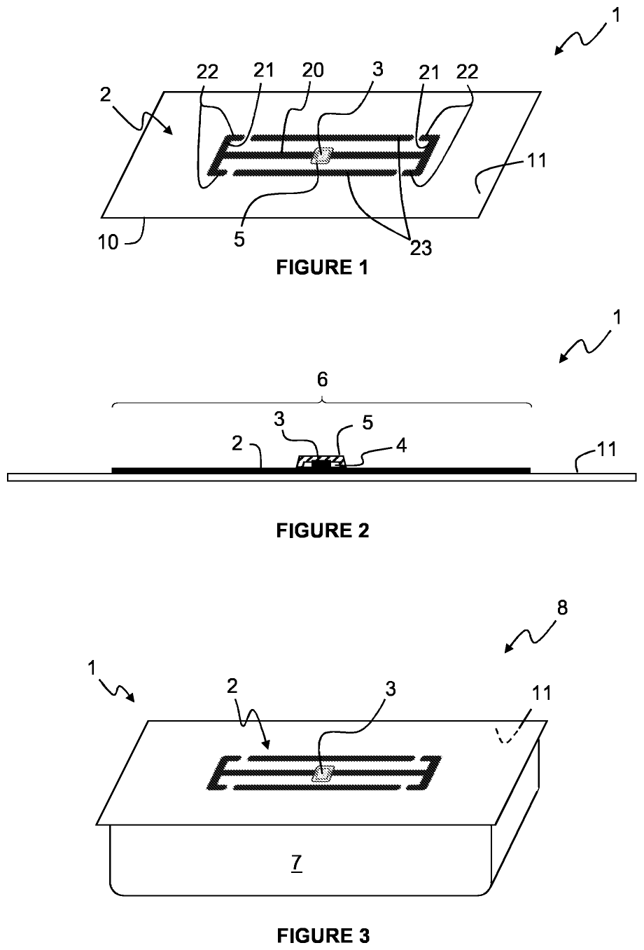

FIG. 1 is a perspective view of a packaging film according to an embodiment of the invention;

FIG. 2 is a section view through the length of the packaging film of FIG. 1;

FIG. 3 is a perspective view of a package according to an embodiment of the invention;

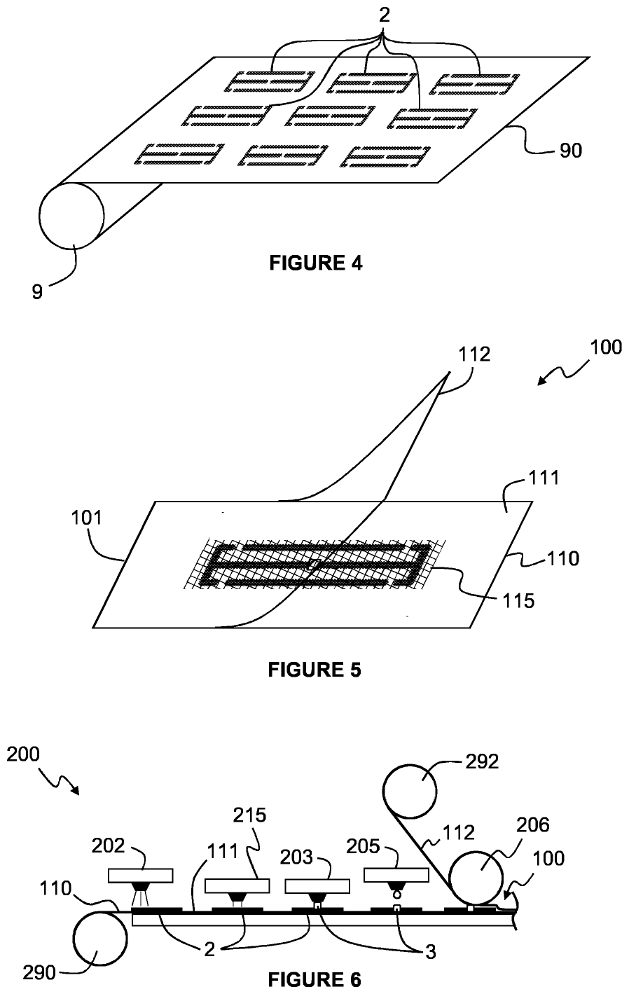

FIG. 4 is a perspective view of a roll of packaging film according to an embodiment of the invention;

FIG. 5 is a perspective view of a laminated packaging film according to an embodiment of the invention;

FIG. 6 is a schematic view of an apparatus for forming the laminated packaging film of FIG. 5;

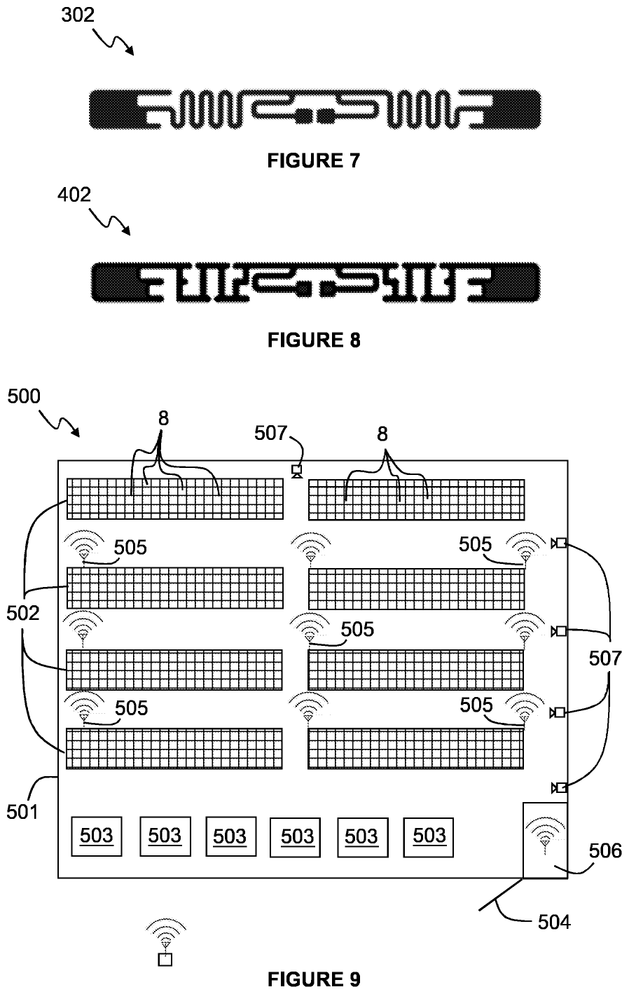

FIG. 7 is a plan view of an alternative antenna design for use with the invention;

FIG. 8 is a plan view of a further alternative antenna design for use with the invention; and

FIG. 9 is a schematic view of an inventory monitoring system according to an embodiment of the invention.

Referring now to FIGS. 1 and 2, there is shown a packaging film 1 according to an embodiment of the invention. The packaging film 1 includes a sheet 10 of polyethylene terephthalate having a thickness of 100 μm. The packaging film 1 also includes an antenna 2 printed on a first major surface 11 of the sheet 10, an electronic identification device 3 secured to the first major surface 11 by a conductive adhesive 4 such that it is and in contact with the antenna 2 and a coating 5 covering the electronic identification device 3.

The antenna 2 includes a longitudinal stem 20 with a lateral element 21 at each end extending perpendicular to the longitudinal stem 20. Each end of each lateral element 21 terminates with a foot 22 extending at a right angle back toward the other lateral element 21. The antenna 2 also includes a pair of longitudinal elements 23 parallel to the stem 20 and extending between each pair of opposed feet 22 of the lateral elements 21. The antenna 2 is designed to operate in radio frequency bands of between 865.6 to 867.6 MHz, but these bands may vary depending on the requirements and/or jurisdictions within which the packaging film 1 is to be used.

The antenna 2 is formed of a conductive heat or light cured black carbon ink having a sheet resistivity at 25 μm of approximately 10 to 20 Ohms/sq. In this embodiment, the antenna 2 is approximately 100 μm thick. However, it is envisaged that the antenna 2 could be thicker or thinner, but it is expected that most applications would require a thickness of between about 30 μm and 200 μm to ensure a balance between flexibility of the packaging film 1 and performance of the antenna 2. In this embodiment, the ink is printed on the surface 11 using an ultraviolet flexography screen printing process, although it is also envisaged that it may be printed using any suitable process, including but not limited to gravure, digital, screen or any other printing process.

The electronic identification device 3 is a radio frequency identification chip in this embodiment. One example of such a device 3 is a chip with a Higgs™ 4 integrated circuit available from Alien Technology Corporation. The device 3 may be a packaged silicon chip, which is typically 1-2 mm in size, but is preferably a bare die silicon chip having a size of less than 0.5 mm. The latter chip is particularly suited to high speed reel to reel assembly processes and the reduced size further reduces the metallic content, thereby reducing the likelihood of detection when the film 1 passes through a metal detector (not shown). Other chip designs are also envisaged and these need not comprise radio frequency identification technologies. Any other suitable active or passive electronic identification technologies may be used, but low cost and complexity is preferable.

The conductive adhesive 4 is a silver based conductive epoxy in this embodiment, although other adhesives 4, which are preferably but not necessarily conductive, are also envisaged depending on the method of assembly. In some embodiments, the conductive adhesive 4 may be omitted where securement and sufficient contact between the antenna 2 and the electronic identification device 3 can be ensured without such an adhesive 4.

The coating 5 in this embodiment is in the form of a black fast cure flexible epoxy, shown as transparent or translucent in the drawings for clarity. Other suitable coatings 5 are also envisaged. The coating 5 encapsulates the electronic identification device 3 and adhesive 4 on the film 1.

The antenna 2 and device 3 coupled thereto by the conductive adhesive 4 and protective coating 5, together provide a radio frequency identification (RFID) tag 6. The film 1 is then secured to a thermoformed plastic tray 7 to provide a closure, thereby forming a sealed package 8, shown in FIG. 3. In this embodiment, the film 1 is oriented with the first major surface 11 lowermost, such that the RFID tag 6 is contained within the package 8, thereby precluding its accidental or intentional removal. It is envisaged that the package 8 may also take the form of a flexible sleeve (not shown) or other package design, for example consisting mainly or solely of the sheet 10 or a similar film material. It is also envisaged that the packaging film 1 be replaced with a rigid packaging medium (not shown).

The applicants have determined through testing that the RFID tag 6 performed particularly well, with detection and reading having been possible at several meters using a handheld commercially available RFID reader. The applicants also found that the package 8, filled with a meat product (not shown), was able to pass through a conventional metal detector (not shown) without detection, the metal detector (not shown) having a sensitivity set to exceed the requirements for food safety in the UK.

Referring now to FIG. 4, there is shown a roll 9 of a polymer film 90 on which an array of antennae 2 is printed. The roll 9 is configured to be incorporated in a packaging system (not shown) in which a plurality of packages 8 are formed which contain a food product (not shown). In this configuration, the electronic identification devices 3 could be secured to the polymer film 90 and connected to the antennae 2 during the packaging process, for example immediately before, during or after the film 90 is secured to the trays 7 containing food product (not shown) and cut to form independent packages 8. The film 90 could have frangible lines (not shown) delineating individual portions intended to form the closure of a package 8.

Additionally or alternatively, the roll 9 may comprise an intermediate product, whereby the polymer film 90 with printed antennae 2 is fed through an apparatus which installs the identification devices 3 prior to its use in a packaging apparatus.

Turning now to FIG. 5 there is shown a packaging film 100 according to another embodiment of the invention. The packaging film 100 according to this embodiment is similar to the aforementioned film 1, wherein like features are labelled with like reference numerals and will not be described further herein. The packaging film 100 according to this embodiment differs in that it is in the form of a laminate 101, which includes a pair of sheets 110, 112 of polyethylene terephthalate each having a thickness of 70 μm. In this embodiment, the antenna 2 is printed on a first major surface 111 of a first sheet 110 and a conductive mesh pattern 115 is printed over the antenna 2 to improve its conductivity. The conductive mesh pattern 115 in this embodiment is a square grid formed by a silver based ink with a thickness of approximately 10 μm and a surface area coverage or fill factor of approximately 10%. Other patterns, materials, non-ferrous metals, thicknesses and fill factors are also envisaged and would depend on the application and the required characteristics of the RFID tag 6.

The electronic identification device 3 is secured to a first sheet 110 using a conductive adhesive 4 in a similar manner and using similar components to those described above in relation to the first embodiment. However, the coating 5 is omitted and the antenna 2, the conductive mesh pattern 115 and the electronic identification device 3 are sandwiched between the first sheet 110 and a second sheet 112, which are laminated together.

This arrangement has the advantage that the RFID tag 6 is completely isolated from both the inside of the package 8 and the external environment. Whilst the coating 5 may be included in this embodiment, it may not be necessary, particularly if the first major surface 111 of the first sheet 110, which carries the electronic identification device 3, faces the inside of the package 8.

FIG. 6 illustrates an apparatus 200 for forming the laminated packaging film 100 described above. The apparatus 200 includes a first polymer film roll 290 for providing the first sheet 110, a second polymer film roll 292 for providing the second sheet 112, an antenna printing station 202, a mesh printing station 215, an chip depositing station 203, an optional coating station 205 and a laminating roller 206.

The antenna printing station 202 prints the carbon ink onto the first surface 111 of the first sheet 110 to form the antenna 2 as it is dispensed from the first polymer film roll 290. The mesh printing station 215 then prints the silver based conductive mesh patter 115 onto the antenna 2. The chip depositing station 203 then deposits an electronic identification device 3 wetted with an uncured conductive adhesive 4.

The coating station 205, if present, then deposits the coating 5 onto the electronic identification device 3. The second polymer film roll 292 feeds the second sheet 112 to the laminating roller 206 and the RFID tag 6 is laminated between the sheets 110, 112 as it passes beneath the laminating roller 206.

At least part of the apparatus 200 may be incorporated into a packaging system (not shown), whereby the laminated packaging film 100 is formed as an integral part of the packaging process.

FIGS. 7 and 8 show alternative antenna designs 302, 402 which have also been found to function well with the aforementioned other components 3, 4, 5 of the RFID tag 6.

Turning now to FIG. 9, there is shown an inventory monitoring system 500 according to an embodiment of the invention. The monitoring system 500 is located within a retail shop 501 having a plurality of shelving units 502, cashier stations 503 and an exit 504, as is conventional. The monitoring system 500 is configured to monitor the presence and location of a plurality of packages 8 each carrying a respective RFID tag 6. The packages 8 are located on the shelving units 502. The monitoring system 500 includes a plurality of wireless RFID readers 505 at various locations across the retail shop 501 and a central control station 506 adjacent the exit 504. The wireless RFID readers 505 and cashier stations 503 are operable to communicate with the control station 506. The monitoring system 500 also includes a plurality of video (e.g. CCTV) cameras 507 throughout the retail shop 501 all of which are operatively connected to the control station 506.

In use, when packages 8 are placed on the shelving units 502, the inventory monitoring system 500 logs them as inventory and tracks their presence and location within the store using the RFID readers 505, which send interrogation signals at regular intervals. When packages 8 are purchased at one of the cashier stations 503, the cashier station 503 sends a signal to the control station 506 together with the identification details of the purchased package 8.

When one of the packages 8 is no longer detected by an RFID reader 505 associated with a particular zone, the system 500 determines whether it is detected by another RFID reader 505 associated with another (e.g. adjacent) zone, thereby indicating that a customer has selected the package 8. If no such RFID reader 505 detects the package, the system 500 alerts a member of staff of the last known zone of the missing package 8. The system 500 may enable a member of staff to review video footage from an adjacent video camera 507 to determine the event that caused the signal to be lost (for example, if a shoplifter placed the item in a foil lined container or garment).

In addition, the monitoring system 500 may also alert a member of staff if it detects that one of the packages 8 is transported from the relevant zone to the exit 504 and out of the retail shop 501 without receiving a signal from one of the cashier stations 503 indicating that the package was purchased. It will be appreciated by those skilled in the art that the control station 506 may perform other useful operations. For example, the control station 506 may be configured to track and record the movements of each package 8. In some cases (e.g. in the case of highly valuable products), the control station 506 may be configured to track and record video footage associated with the movement of the package, thereby enabling the authorities to readily access the relevant footage associated with a shoplifting incident.

Whilst the above disclosure illustrates several aspects and embodiments of the invention, it will be appreciated by those skilled in the art that several variations are envisaged without departing from the scope of the invention. It will also be appreciated by those skilled in the art that any number of combinations of the aforementioned features and/or those shown in the appended drawings provide clear advantages over the prior art and are therefore within the scope of the invention described herein.

1-20. (canceled)

21. A roll of packaging film formed of one or more layers of flexible plastics sheet material, the film comprising:
an array of antennae formed of a non-metallic material printed directly on a surface of the packaging film; and
an electronic identification device operatively connected to each antenna, wherein the electronic identification device is less than 1 mm² in plan.

22. A roll of packaging film according to claim 21, wherein the film is effectively invisible to or undetectable by a metal detector.

23. A roll of packaging film according to claim 21, wherein the electronic identification device comprises an integrated circuit secured to the film by a conductive adhesive.

24. A roll of packaging film according to claim 23, wherein the conductive adhesive comprises a silver based conductive epoxy material.

25. A roll of packaging film according to claim 21, wherein the film comprises a laminate with a first layer on which the antenna is printed and a second layer secured to the first layer such that the antenna and the electronic identification device are sandwiched between the layers.

26. A roll of packaging film according to claim 21 comprising at least one layer of polyethylene terephthalate having a thickness of 300 μm or less and the thickness of the antenna is 100 μm or less.

27. A roll of packaging film formed of one or more layers of flexible plastics sheet material, the film comprising:
an array of antennae formed of a non-metallic material printed directly on a surface of the packaging film;
wherein each antenna is adapted for operative connection with an electronic identification device that is less than 1 mm² in plan.

28. A roll of packaging film according to claim 27 comprising a conductive mesh pattern printed on the surface and in contact with the antenna.

29. A roll of packaging film according to claim 28, wherein the thickness of the conductive mesh pattern is 30 μm or less.

30. A roll of packaging film according to claim 28, wherein the fill factor of the conductive mesh pattern is 20% or less.

31. A roll of packaging film according to claim 28, wherein the conductive mesh pattern comprises a silver material.

32. A roll of packaging film according to claim 27, wherein the non-metallic material comprises a carbon or silica material.

33. A roll of packaging film according to claim 32, wherein the non-metallic material comprises a graphene, graphene oxide or fullerene material.

34. A roll of packaging film according to claim 27, wherein the film comprises a laminate with a first layer on which the antenna is printed and a second layer secured to the first layer such that the antenna is sandwiched between the layers.

35. A packaging film formed of one or more layers of flexible plastics sheet material, the film comprising:
an antenna formed of a non-metallic material printed directly on a surface of the packaging film; and
an electronic identification device operatively connected to the antenna, wherein the electronic identification device is less than 1 mm² in plan.

36. A packaging film according to claim 35, wherein the film is effectively invisible to or undetectable by a metal detector.

37. A packaging film according to claim 35 comprising a conductive mesh pattern printed on the surface and in contact with the antenna.

38. A package comprising a film according to claim 35.

39. Package according to claim 38, wherein the antenna is printed directly on an internally facing surface of the package.

40. An inventory monitoring system comprising an electronic identification device reader and a plurality of packages according to claim 38.
